(19) United States
(12) Patent Application Publication
(10) Pub. No.: US 2018/0161801 A1
(43) Pub. Date: Jun. 14, 2018

(54) SYSTEM AND METHOD OF APPLYING SEALER

(71) Applicants: Hyundai Motor Company, Seoul (KR); KIA Motors Corporation, Seoul (KR)

(72) Inventor: Taeheun JIN, Gyeongsan-si (KR)

(73) Assignees: Hyundai Motor Company, Seoul (KR); KIA Motors Corporation, Seoul (KR)

(21) Appl. No.: 15/682,147

(22) Filed: Aug. 21, 2017

(30) Foreign Application Priority Data
Dec. 14, 2016 (KR) 10-2016-0170773

(51) Int. Cl. B05C 5/00; B05C 11/10; B05C 5/02; B60R 13/06

(52) U.S. Cl. CPC B05C 5/001; B60R 13/06; B05C 5/0212; B05C 11/1013

(57) ABSTRACT

A system for applying a sealer disclosure includes a supplying unit; a circulating unit; a temperature compensating unit; an applying gun; and a quantitative discharging unit. The supplying unit is configured to supply a sealer. The circulating unit is configured to circulate the sealer supplied from the supplying unit along a predetermined circulation line. The temperature compensating unit is disposed at one side of the circulation line and configured to compensate for a temperature of the circulated sealer to a predetermined temperature range. The applying gun is disposed at a front end of an arm of a robot so as to discharge a part of the circulated sealer through a nozzle. The quantitative discharging unit is configured to pressure-feed a predetermined quantity of sealer circulating along the circulation line to the nozzle.

### CROSS-REFERENCE TO RELATED APPLICATION

This application claims priority to and the benefit of Korean Patent Application No. 10-2016-0170773 filed in the Korean Intellectual Property Office on Dec. 14, 2016, the entire contents of which are incorporated herein by reference.

### BACKGROUND OF THE DISCLOSURE

### (a) Field of the Disclosure

The present disclosure relates to a system and a method of applying a sealer, in particular of applying a sealer to a roof ditch of a vehicle.

### (b) Description of the Related Art

In a vehicle, a bonding part between a roof and a side panel is fastened with a roof molding after spot welding.

Productivity may be degraded and a mounting error may occur while an operator fastens the roof molding to a ditch part.

Recently, a technology for automatically applying a sealer to a roof attachment part, instead of a roof molding, to remove the roof molding, and improving a quality of an exterior appearance has been introduced.

Further, research on a method and an apparatus for improving the quality of a sealer application, improving application accuracy, and improving the quality of the sealer is currently being conducted.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to provide a system and a method of applying a sealer, which are capable of automatically applying the sealer to a roof ditch of a vehicle and determining the quality of the application, thereby improving both productivity and quality of the sealer.

An exemplary embodiment of the present disclosure provides a system for applying a sealer, including: a supplying unit configured to supply a sealer; a circulating unit configured to circulate the sealer supplied from the supplying unit along a predetermined circulation line; a temperature compensating unit disposed at one side of the circulation line and configured to compensate for a temperature of the circulated sealer to a predetermined temperature range; an applying gun disposed at a front end of an arm of a robot so as to discharge the circulated sealer through a nozzle; and a quantitative discharging unit configured to pressure-feed a predetermined quantity of sealer circulating along the circulation line to the nozzle.

The quantitative discharging unit may include: a discharge motor; and a cylinder that is moved by the discharge motor to pressure-feed the predetermined quantity of sealer to the nozzle.

The discharge motor may drive the cylinder through a ball screw.

The circulating unit may include: a filter disposed to filter foreign substances from the sealer; a pressure detecting unit disposed to detect a pressure of the circulated sealer; and a circulating pump that circulates the sealer through the circulation line.

The supplying unit may include: a sealer storing unit that contains the sealer to be supplied; a supply pump that pumps the sealer contained in the sealer storing unit to the circulating unit; and a supply motor that applies rotational force to the supply pump.

The system may further include a vision mounted at one side of the applying gun in the front end of the arm of the robot, in which the vision may include: a laser radiating unit that radiates a linear laser to a vehicle body; a profile detecting unit that detects a profile of the vehicle body; a camera disposed so as to photograph a front image; and a light that radiates light.

The temperature compensating unit may include: a heating/cooling unit, that is disposed to heat the sealer or cool the sealer by a supplied power source; and a heat radiating unit that absorbs heat energy of the sealer and discharges the heat energy to the outside.

The heating/cooling unit may include a thermoelectric element, and the heat radiating unit may include a heatsink and a cooling fan, in which heat energy is stored.

The temperature compensating unit may further include a temperature detecting unit that detects the temperature of the circulated sealer.

The temperature of the circulated sealer may be controlled to be within a predetermined temperature range by controlling the heating/cooling unit and the heat radiating unit according to a temperature detected by the temperature detecting unit.

Another exemplary embodiment of the present disclosure provides a method of applying a sealer, including: circulating a sealer along a circulation line by using a circulating pump; compensating for a temperature of the circulated sealer by using a temperature compensating unit; discharging the sealer that has circulated along the circulation line by using a quantitative discharging unit; and applying the sealer discharged from the quantitative discharging unit to a vehicle body by using an applying gun.

The method may further include supplying the sealer to one side of the circulation line by using a supplying unit.

In applying of the sealer, a robot may move the applying gun along a predetermined route of the vehicle body.

The method may further include: detecting the vehicle body by using a vision; and detecting the sealer applied on the vehicle body by using the vision.

The compensating for the temperature may include detecting the temperature of the circulated sealer.

The circulating of the sealer may include filtering foreign substances from the circulated sealer and detecting a pressure of the sealer.

According to the exemplary embodiments of the present disclosure, the sealer applying system may stably maintain a temperature of a sealer applied onto a roof ditch, thereby improving a quality of the sealer.

### BRIEF DESCRIPTION OF THE DRAWINGS

FIG. 1 is a diagram of the general configuration of the sealer applying system according to an exemplary embodiment of the present disclosure.

FIG. 2 is a perspective view of part of the quantitative discharging unit and the applying gun of the sealer applying system according to the exemplary embodiment of the present disclosure.

FIG. 3 is a perspective view of part of the circulating unit and the temperature compensating unit in the sealer applying system according to the exemplary embodiment of the present disclosure.

FIG. 4 is a perspective view of part of the supplying unit of the sealer applying system according to the exemplary embodiment of the present disclosure.

FIG. 5 is a flowchart illustrating the sealer applying method according to an exemplary embodiment of the present disclosure.

### DETAILED DESCRIPTION OF THE EMBODIMENTS

Hereinafter, an exemplary embodiment of the present disclosure will be described in detail with reference to the accompanying drawings.

In addition, the size and thickness of each configuration shown in the drawings are arbitrarily shown for understanding and ease of description, but the present disclosure is not limited thereto, and the thickness of layers, films, panels, regions, etc., are exaggerated for clarity.

A part irrelevant to the description may be omitted to clearly describe the exemplary embodiment of the present disclosure, and the same elements will be designated by the same reference numerals throughout the specification.

In a description below, names of constituent elements are used as “a first . . . ”, “a second . . . ”, and the like, but the name of the constituent element is not limited to the order.

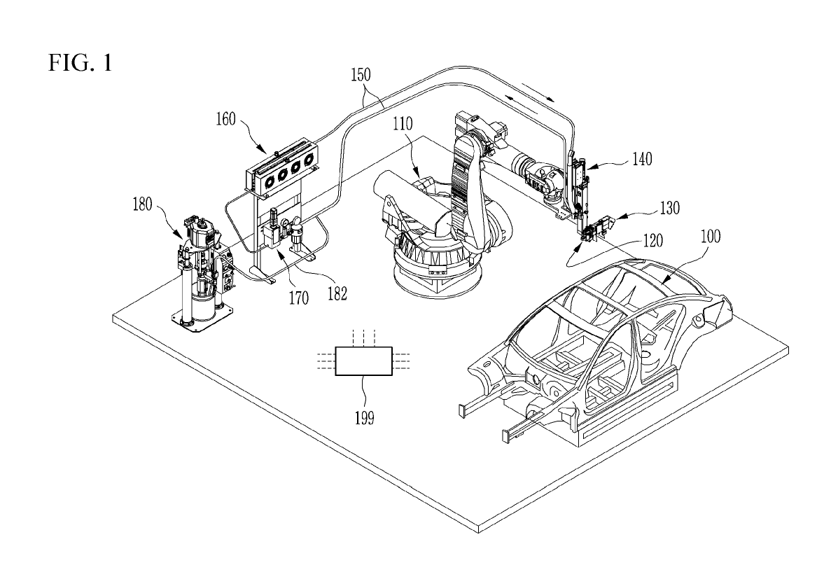

FIG. 1 is a diagram of the general configuration of a sealer applying system according to an exemplary embodiment of the present disclosure.

Referring to FIG. 1, the sealer applying system includes a supplying unit 180, a filling line 182, a circulating unit 170, a temperature compensating unit 160, a circulation line 150, a robot 110, an applying gun 120, a quantitative discharging unit 140, a vision 130, a vehicle body 100, and a control unit 199.

The temperature compensating unit 160 is disposed in an upper portion at one side of the circulation line 150, and the circulating unit 170 is disposed in a lower portion of the temperature compensating unit 160. The quantitative discharging unit 140 is disposed at the other side of the circulation line 150, the applying gun 120 is disposed at a lower end of the quantitative discharging unit 140, and the vision 130 is installed at one side of the applying gun 120.

The filling line 182 connects the supplying unit 180 and one side of the circulation line 150. The supplying unit 180 supplies a sealer to one side of the circulation line 150 through the filling line 182.

The quantitative discharging unit 140 is disposed in a front end of an arm of the robot 110. The robot 110 may move the quantitative discharging unit 140, the applying gun 120, and the vision 130 along an exterior of the vehicle body 100.

The control unit 199 supplies the sealer to the circulation line 150 by controlling the supplying unit 180; controls the temperature of the sealer circulating along the circulation line 150 within a predetermined temperature range by controlling the temperature compensating unit 160; and circulates the sealer along the circulation line 150 by controlling the circulating unit 170.

Further, the control unit 199 may move the applying gun 120 and the vision 130 along the exterior of the vehicle body 100 by controlling the robot 110, and may detect an appearance of the sealer applied through the applying gun 120 and determine a quality of the sealer application.

The control unit 199 may be implemented by one or more micro-processors operated by a predetermined program, and the predetermined program may include a series of commands for performing a method according to an exemplary embodiment of the present disclosure to be described below.

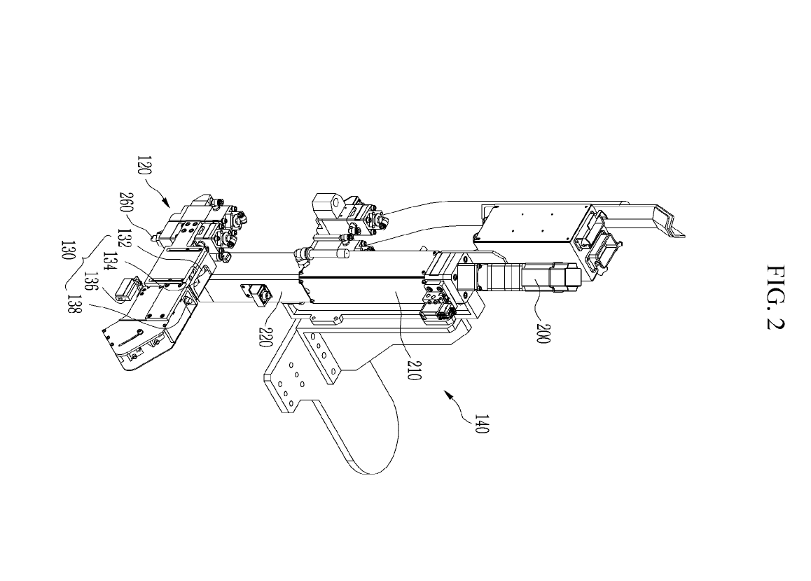

FIG. 2 is a perspective view of a part of the quantitative discharging unit 140 and the applying gun 120 in the sealer applying system according to the exemplary embodiment of the present disclosure.

Referring to FIG. 2, the quantitative discharging unit 140 includes a discharge motor 200 disposed at an upper portion, a cylinder 220 disposed at a lower portion, a ball screw 210 connecting the discharge motor 200 and the cylinder 220 as constituent elements, and the applying gun 120 disposed at one side of the cylinder 220. Further, a nozzle 260, through which the sealer is discharged, is formed in a lower portion of the applying gun 120.

When the discharge motor 200 is operated, the discharge motor 200 operates a piston (not illustrated) of the cylinder 220 through the ball screw 210, and pumps the sealer filled in a chamber of the cylinder 220. Further, the sealer pumped by the cylinder 220 is injected to the outside through the nozzle 260 of the applying gun 120.

The vision 130 is installed at one side of the cylinder 220, and the vision 130 includes a profile sensor 132, a camera 134, a laser radiating unit 136, and a light 138. The profile sensor 132 is disposed so as to detect a profile of the vehicle body or the applied sealer, the camera 134 photographs a front situation, the laser radiating unit 136 radiates a line laser to the vehicle body, and the light 138 radiates light in a front direction.

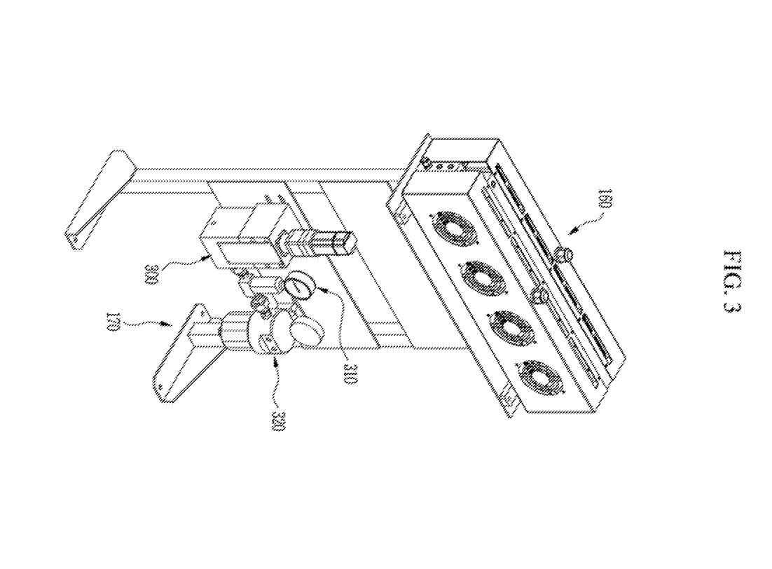

FIG. 3 is a perspective view of part of the circulating unit 170 and the temperature compensating unit 160 in the sealer applying system according to the exemplary embodiment of the present disclosure.

Referring to FIG. 3, the circulating unit 170 includes a filter 320, a pressure detecting unit 310, and a circulating pump 300 as constituent elements. The filter 320 filters foreign substances included in an inflow sealer, the pressure detecting unit 310 detects a pressure of the circulated sealer, and the circulating pump 300 pumps the sealer and circulates the sealer through the circulation line 150.

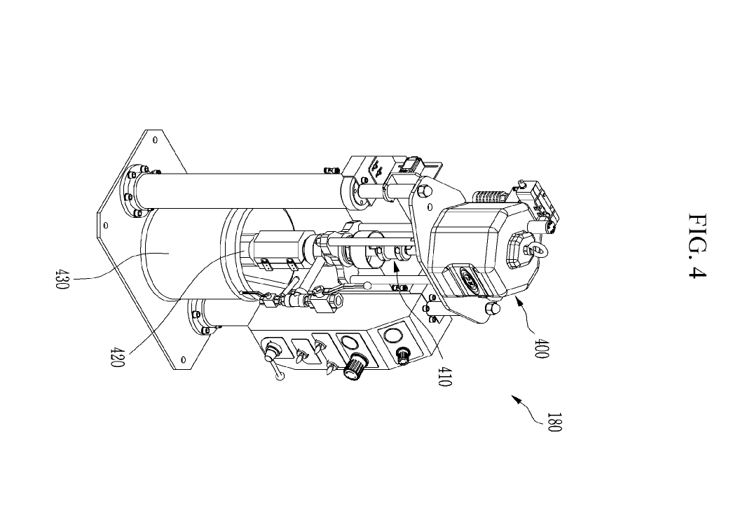

FIG. 4 is a perspective view of part of the supplying unit 180 in the sealer applying system according to the exemplary embodiment of the present disclosure.

Referring to FIG. 4, the supplying unit 180 includes a supply motor 400, a coupling 410, a sealer storing unit 430, and a supply pump 420 as constituent elements.

The sealer storing unit 430 contains the sealer; the supply pump 420 pumps the sealer of the sealer storing unit 430 to the filling line 182; and the coupling 410 transfers rotational force of the supply motor 400 to the supply pump 420.

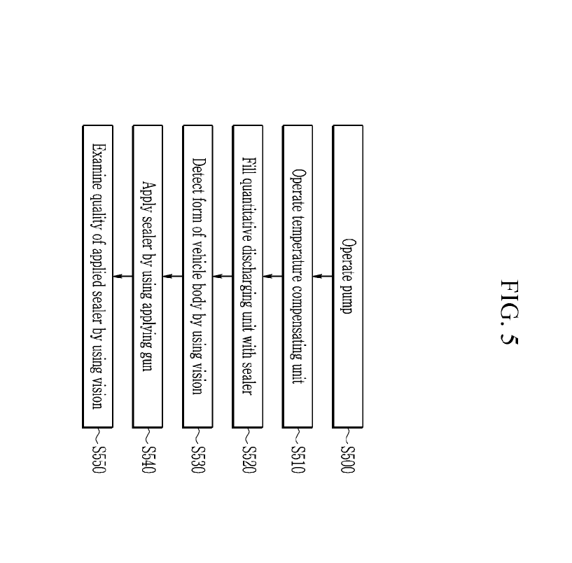

FIG. 5 is a flowchart illustrating a sealer applying method according to an exemplary embodiment of the present disclosure.

Referring to FIG. 5, in order to apply a sealer, in operation step S500, the control unit 199 operates the supply pump 420, supplies the sealer to the circulation line 150, operates the circulating pump 300, and circulates the sealer through the circulation line 150.

In operation step S510, the control unit 199 operates the temperature compensating unit 160 and maintains the temperature of the circulated sealer within a predetermined temperature range. Then, in operation step S520, the control unit 199 fills the cylinder 220 with the sealer through an opening operation of the valve.

In operation step S530, the control unit 199 may detect a form of the vehicle body 100 through the vision 130, and receive shape data of the vehicle body. Further, the control unit 199 may correct the form of the vehicle body 100 in the shape data received through the vision 130.

In operation step S540, the control unit 199 may inject the sealer filled in the cylinder 220 through the nozzle 260 of the applying gun 120 through the ball screw 210 by controlling the discharge motor 200, and apply the sealer to a roof ditch of the vehicle body 100 in a uniform form by controlling the robot 110.

Then, in operation step S550, the control unit 199 may detect a quality of the sealer applied to the vehicle body 100 by using the robot 110 and the vision 130.

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims.

What is claimed is:

1. A system for applying a sealer, comprising:
a supplying unit configured to supply a sealer;
a circulating unit configured to circulate the sealer supplied from the supplying unit along a predetermined circulation line;
a temperature compensating unit disposed at one side of the circulation line and configured to compensate for a temperature of the circulated sealer to a predetermined temperature range;
an applying gun disposed at a front end of an arm of a robot so as to discharge circulated sealer through a nozzle; and
a quantitative discharging unit configured to pressure-feed a predetermined quantity of sealer circulating along the circulation line to the nozzle.

2. The system of claim 1, wherein:
the quantitative discharging unit includes:
a discharge motor; and
a cylinder that is moved by the discharge motor to pressure-feed the predetermined quantity of sealer to the nozzle.

3. The system of claim 2, wherein:
the discharge motor drives the cylinder through a ball screw.

4. The system of claim 1, wherein:
the circulating unit includes:
a filter disposed to filter foreign substances from the sealer;
a pressure detecting unit disposed to detect a pressure of the circulated sealer; and
a circulating pump that circulates the sealer through the circulation line.

5. The system of claim 1, wherein:
the supplying unit includes:
a sealer storing unit that contains the sealer to be supplied;
a supply pump that pumps the sealer contained in the sealer storing unit to the circulating unit; and
a supply motor that applies rotational force to the supply pump.

6. The system of claim 1, further comprising:
a vision mounted at one side of the applying gun in the front end of the arm of the robot,
wherein the vision includes:
a laser radiating unit that radiates a linear laser to a vehicle body;
a profile detecting unit that detects a profile of the vehicle body;
a camera disposed so as to photograph a front image; and
a light that radiates light.

7. A method of applying a sealer, comprising:
circulating a sealer along a circulation line by using a circulating pump;
compensating for a temperature of the circulated sealer by using a temperature compensating unit;
discharging the sealer that has circulated along the circulation line by using a quantitative discharging unit; and
applying the sealer discharged from the quantitative discharging unit to a vehicle body by using an applying gun.

8. The method of claim 7, further comprising:
supplying the sealer to one side of the circulation line by using a supplying unit.

9. The method of claim 7, wherein:
applying of the sealer includes
a robot that moves the applying gun along a predetermined route [form?] of the vehicle body.

10. The method of claim 7, further comprising:
detecting the vehicle body by using a vision; and
detecting the sealer applied on the vehicle body by using the vision.

11. The method of claim 7, wherein:
compensating for the temperature includes detecting the temperature of the circulated sealer.

12. The method of claim 7, wherein:
circulating the sealer includes filtering foreign substances from the circulated sealer and detecting a pressure of the sealer.
